(19) United States
(12) Patent Application Publication
(10) Pub. No.: US 2004/0268053 A1
(43) Pub. Date: Dec. 30, 2004

(54) Method, device, and computer product for data storage control

(75) Inventor: Naoya Fujisaki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/914,268

(22) Filed: Aug. 10, 2004

Related U.S. Application Data
(63) Continuation of application No. PCT/JP02/01259, filed on Feb. 14, 2002.

(51) Int. Cl. G06F 12/00

(52) U.S. Cl. 711/141; 711/154

(57) ABSTRACT

There are provided an XML engine which receives data for storage, and a policy control unit which refers to a pre-specified policy set taking into account the characteristics (degree of popularity, urgency, importance, etc.) of the data and stores the data in a recording medium (such as a disk and a cache memory) of a predetermined node.

### TECHNICAL FIELD

The present invention relates to a method, device, and a computer product for data storage control. More specifically, the present invention relates to storing data in a recording medium (such as a disk and a cache memory) of a predetermined node according to a pre-specified policy.

### BACKGROUND ART

Recently, with the rapid spread of the Internet, broadband network, cellular phones, PDA (Personal Digital (Data) Assistants), and the like, there has been a remarkable technical development in electronic government and electronic commerce. More specifically, such electronic government and electronic commerce systems deal with large volumes of data, demanding high performance and high reliability.

When the data is managed in a unified manner on a single server, the access gets concentrated on a specific data according to the degree of popularity, urgency and importance of the data. The undesirable outcome of this is prolongation of response time.

Coventionally, with the view of fast accessibility, data was stored in a cache server, and was retrieved from the cache server in response to the access request from a client.

However, in the conventional method, when the data was stored in the cache server, the characteristics of the data such as the degree of popularity, urgency, and importance were not taken into consideration. In other words, data was difficult to access since no policy was specified to the data when storing.

### DISCLOSURE OF THE INVENTION

It is an object of the present invention to provide a technology having better response when accessing the data.

A computer program according to an aspect of the present invention contains instructions which when executed on a computer realize the steps of receiving data for storage; referring to a policy that is pre-specified by taking into account characteristics of the data for storage; and storing the data for storage on a recording medium of a predetermined node based on the referring.

A method according to another aspect of the present invention is a method for data storage control and includes receiving data for storage; referring to a policy that is pre-specified by taking into account characteristics of the data for storage; and storing the data for storage on a recording medium of a predetermined node based on the referring.

An apparatus according to still another aspect of the present invention is an apparatus for data storage control and includes receiving unit that receives data for storage; a policy referring unit that refers to a policy that is pre-specified by taking into account characteristics of the data for storage; and control unit that provides a control to store the data for storage on a recording medium of a predetermined node based on the referring.

A computer-readable recording medium according to still another aspect of the present invention stores a computer program that contains instructions which when executed on a computer realize the above method according the present invention.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram illustrating an embodiment according to the present invention;

FIG. 2 is a drawing illustrating a sample format of a policy data 500 employed in the embodiment of the present invention;

FIG. 3 is a flowchart for explaining the basic operations of a data center server illustrated in FIG. 1;

FIG. 4 is a flowchart for explaining the basic operations of cache servers illustrated in FIG. 1;

FIG. 5 is a flowchart for explaining the operation of the cache servers illustrated in FIG. 6 when there is a breakdown;

FIG. 6 is a block diagram for explaining the operation when there is a breakdown of the data center server 100 illustrated in FIG. 1;

FIG. 7 is a block diagram for explaining the operation of the embodiment of the present invention; and

FIG. 8 is a drawing illustrating the structural modifications of an embodiment of the present invention.

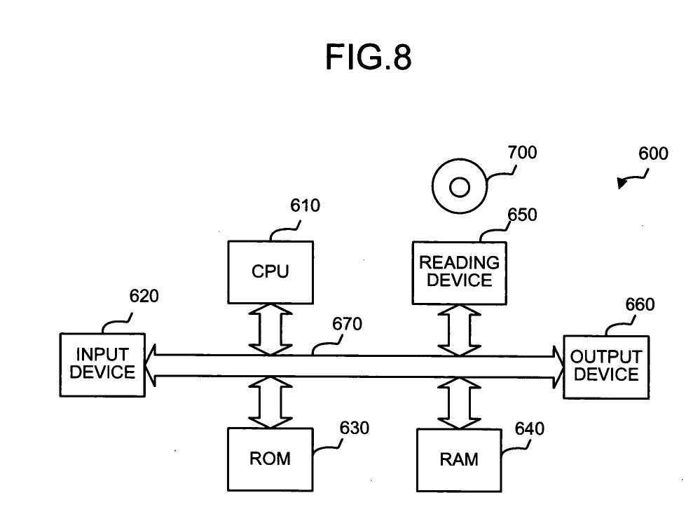

### BEST MODE FOR CARRYING OUT THE INVENTION

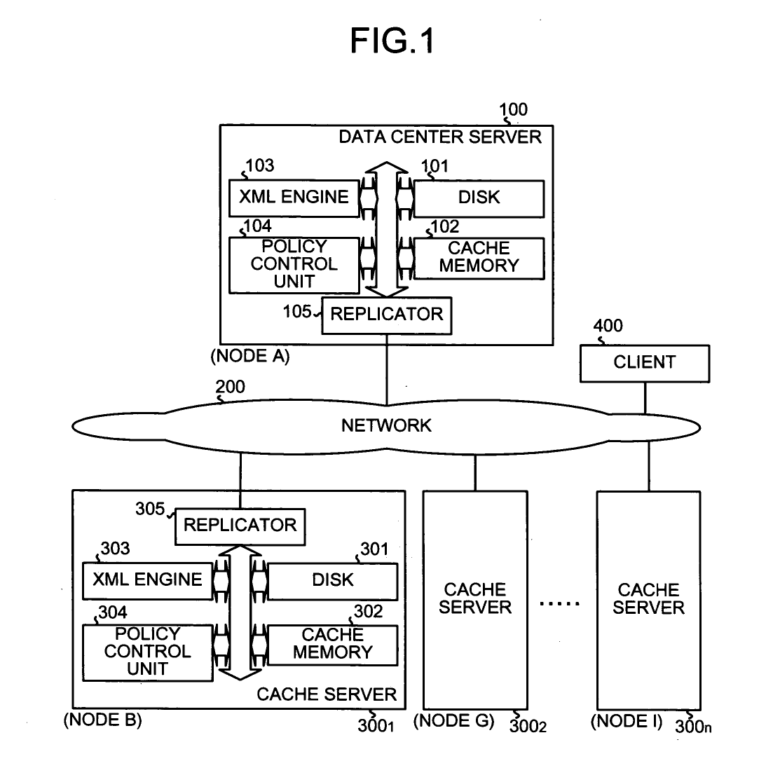

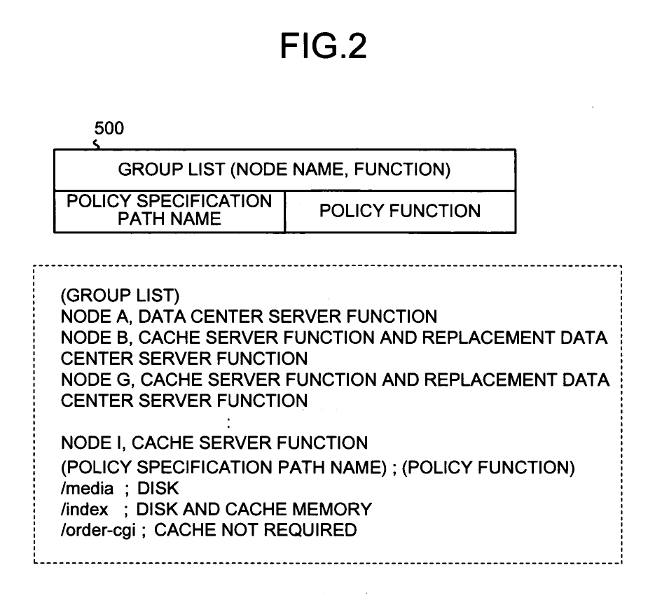

Exemplary embodiments of a method and a computer product according to the present invention are explained here with reference to the accompanying drawings. FIG. 1 is a block diagram illustrating an embodiment according to the present invention. A data center server 100 is installed at node A of a network 200. The data center server 100 stores data in a disk 101 and a cache memory 102 based on a policy data 500 (see FIG. 2) described later.

The disk 101 is a recording medium that has a slower access speed but higher data storage capacity than the cache memory 102. The cache memory 102 is, for instance, a SRAM (Static Random Access Memory), and has a high access speed.

An XML(eXtensible Markup Language) engine 103, for instance, is an XML editor, and is equipped with the functions to edit contents and to receive the stored data and check the script (programming language) contained in the stored data. A policy control unit 104 refers to the policy data 500 illustrated in FIG. 2, and controls the storage of data in a predetermined location (such as the disk and the cache memory) of a predetermined node, based on the policy specified for the data. The policy specified for the data relates to the data's degree of popularity, urgency, importance, and the like.

The policy data 500, shown in FIG. 2, comprises data that includes a group list, a policy specification path name, and a policy function. The group list a list of node names on the network 200 and the functions of the servers at the nodes. In the example shown in FIG. 2, the data center server 100 at node A in FIG. 1 is specified to function as a data center server.

The cache server 300₁ located at node B is specified to function as a cache server and a replacement data center server. A replacement data center server is a backup server that realizes the functions of the data center server 100 when a breakdown of the data center server 100 occurs.

The cache server 300₂ located at node G, is specified to function as a cache server and a replacement data center server. The cache server 300ₙ located at node I is specified to function as a cache server.

The policy specification path name is a path name that specifies the storage location of the data, and also specifies a policy function. For instance, the policy specification path name containing/media specifies that the data is stored on the disk. The data stored on the disk are data which are rarely updated and are comparatively large in size such as an audio data or an image data.

The policy specification path name containing/index specifies not only that the data is stored on the disk but also that a pointer data, which points to the data stored on the disk, is stored in the cache memory. The data is stored in the disk as well as the cache memory for speeding up data search.

The policy specification path name containing/order-cgi specifies that the data is not stored in the cache servers 300₃ through 300ₙ, but is stored only in the data center server 100 and a disk 301 of the replacement data center server. Like the product order data, this data is frequently updated and is data in which the updation sequence is crucial. Such a data, if stored in cache memory, prolongs the response time. Consequently, data is stored in the replacement data center server to serve as a backup.

Returning to FIG. 1, a replicator 105 sends, based on the policy data 500, the data to the specified node via the network 200.

In a cache server 300₁, installed at node B on the network 200, the data is stored on the disk 301 and a cache memory 302, based on the policy data 500 (see FIG. 2). The cache server 300₁ is specified to function as a cache server and a replacement data center server, according to the policy data 500 shown in FIG. 2.

The disk 301 is a recording medium that has a slower access speed than the cache memory 302, but a high data storage capacity. The cache memory 302, for instance a SRAM, is a recording medium with high accessing speed. An XML engine 303 functions similar to the XML engine 103.

A policy control unit 304, refers to the policy data 500 illustrated in FIG. 2, and controls the storage of data in a predetermined location (such as the disk and the cache memory) of a predetermined node, based on the policy specified for the data. The policy specified for the data relates to the data's degree of popularity, urgency, importance, and the like.

The cache server 300₂ located at node G on the network 200 has the same structure as the cache server 300₁. In other words, data in the cache server 300₂ is stored on the disk (not shown) and the cache memory (not shown), based on the policy data 500 (see FIG. 2).

A cache server 300ₙ located at node I on the network 200, has the same structure as the cache server 300₁. In other words, data in the cache server 300ₙ is stored on the disk (not shown) and the cache memory (not shown), based on the policy data 500 (see FIG. 2).

A client 400 is installed at the user end or data center end, and is operated by a general user, a contents editor, a data center administrator, and the like. The client 400 may be a computer terminal, a cellular phone terminal, and the like, which can access the data center server 100 and the cache servers 300₁ through 300ₙ via the network 200.

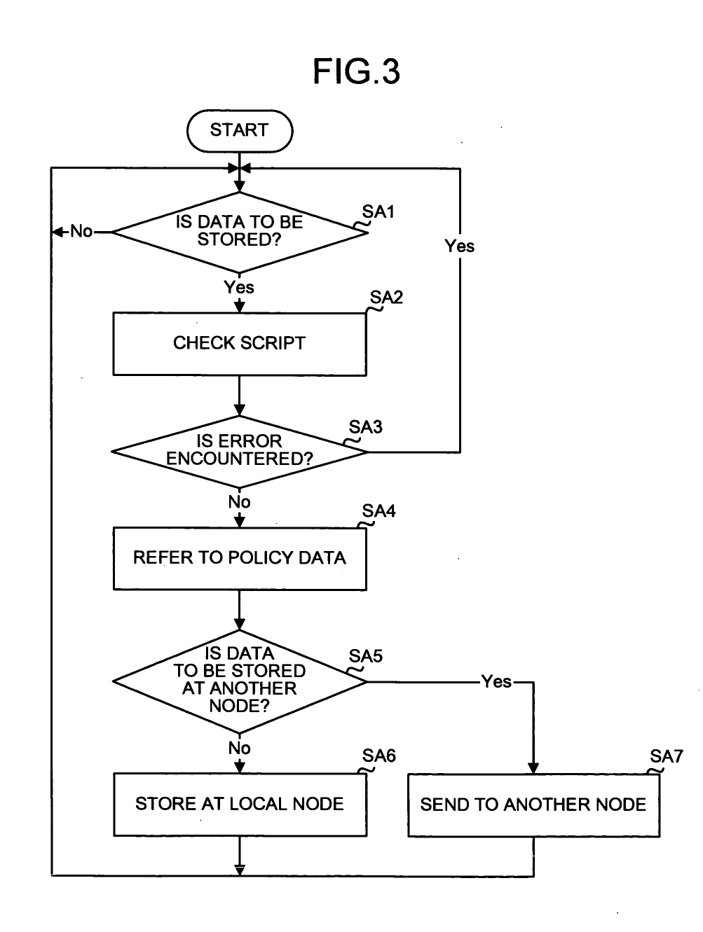

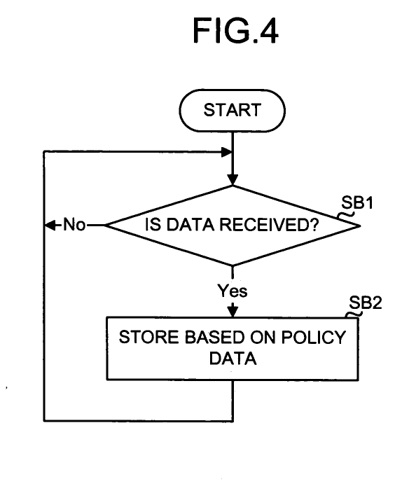

The basic operation of an embodiment according to the present invention is discussed next with reference to the flow charts shown in FIG. 3 and FIG. 4. FIG. 3 is a flowchart for explaining the basic operation of the data center server 100 illustrated in FIG. 1. FIG. 4 is a flowchart for explaining the basic operation of the cache servers 300₁ through 300ₙ illustrated in FIG. 1.

As shown in FIG. 3, in Step SA1, the XML engine 103 of the data center server 100, for instance, checks whether the client 400 operated by a contents editor has requested for data storage in order to save the edit data. If there has been no request, that is if the check result is “No”, Step SA1 is repeated.

As shown in FIG. 4, in Step SB1, the XML engine 303 of the cache server 300₁ checks whether the data for storage is received from the data center server 100. If no data is received, that is, if the check result is “No”, Step SB1 is repeated.

If the data for storage and the policy data 500 (see FIG. 2) are received by the data center server 100 from the client 400 operated by the contents editor (or the data center administrator), the XML engine 103 assesses that data has been received, that is, the check result of the Step SA1 shown in FIG. 1 is “Yes”.

In Step SA2, the XML engine 103 checks whether the received data includes a preset infected script. The infected script may be similar to a computer virus, which may pose problems such as a system crash, and the like. The XML engine 103 performs pseudo-execution of the script contained in the data, and bypasses the data related to the infected script.

In Step SA3, the XML engine 103 checks whether an error is encountered during the pseudo-execution, that is if the data includes an infected script. If error is encountered, that is if the check result is “Yes”, the XML engine 103 suspends the storing process of the data.

If no error is encountered, that is if the check result of Step SA3 is “No”, the policy control unit 104 refers to the policy data 500 (see FIG. 2) in Step SA4. In Step SA5, the policy control unit 104 checks from the group list of the policy data 500 whether the data is to be stored in another node (excluding node A).

For instance, when node B is specified in the group list, the policy control unit 104 assesses that data is to be stored in another node, that is, the check result of Step SA5 is “Yes”. In Step SA7, the replicator 105, via the network 200, sends the data for storage and the policy data 500 to the cache server 300₁ corresponding to node B.

When the data for storage and the policy data 500 are received by the replicator 305 of the cache server ³⁰⁰1, the XML engine 303 assesses that data has been received, that is, the check result of Step SB1 shown in F1G. 4 is “Yes”. In Step SB2, the policy control unit 304 stores the data in a predetermined location (the disk 301, the cache memory 302), based on the policy data 500.

For instance when/media is specified as a policy specification path name shown in FIG. 2, the policy control unit 304 stores the data on the disk 301. When/index is specified as a policy specification path name, the policy control unit 304 stores the data on both the disk 301 and in the cache memory 302.

When node A is specified in the group list of the policy data 500 (see FIG. 2), the policy control unit 104 of the data center server 100 assesses that the node specified is node A, that is, the check result of Step SA5 shown in FIG. 3 is “No”.

In Step SA6, the policy control unit 104 stores the data in a predetermined location (disk 101, cache memory 102) based on the policy data 500.

For instance, when/media is specified as a policy specification path name shown in FIG. 2, the policy control unit 104 stores the data on the disk 101. When/index is specified as a policy specification path name, the policy control unit 104 stores the data on both the disk 101 and in the cache memory 102.

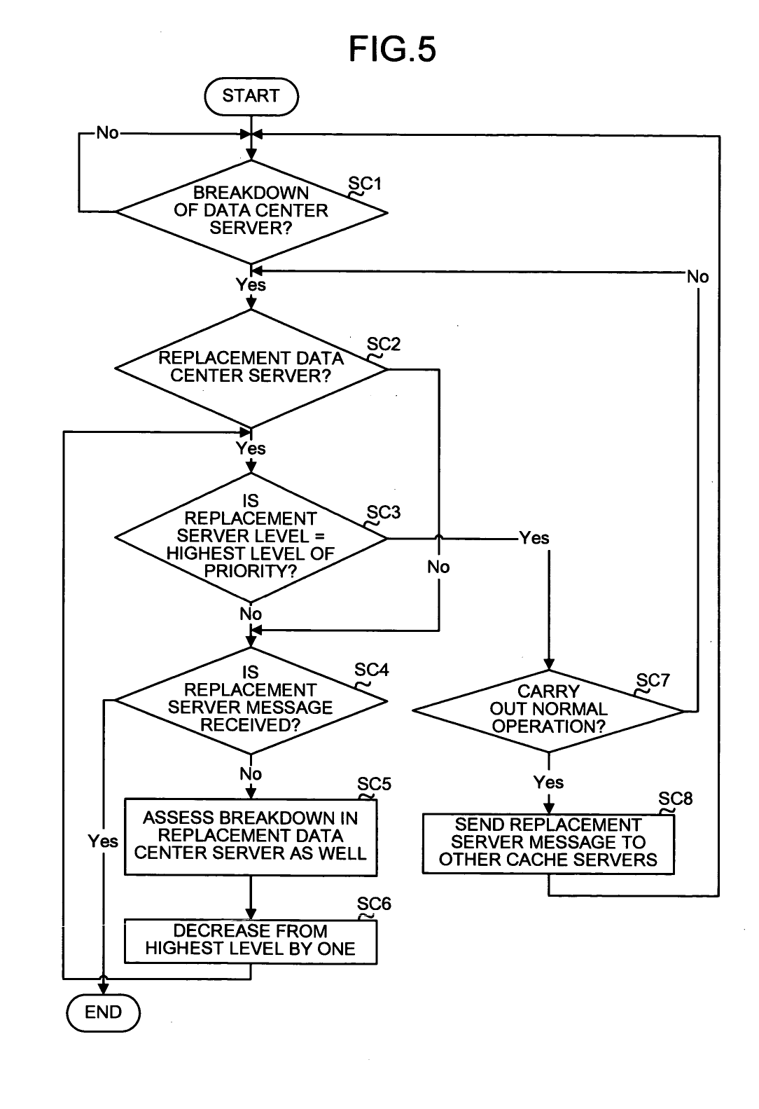

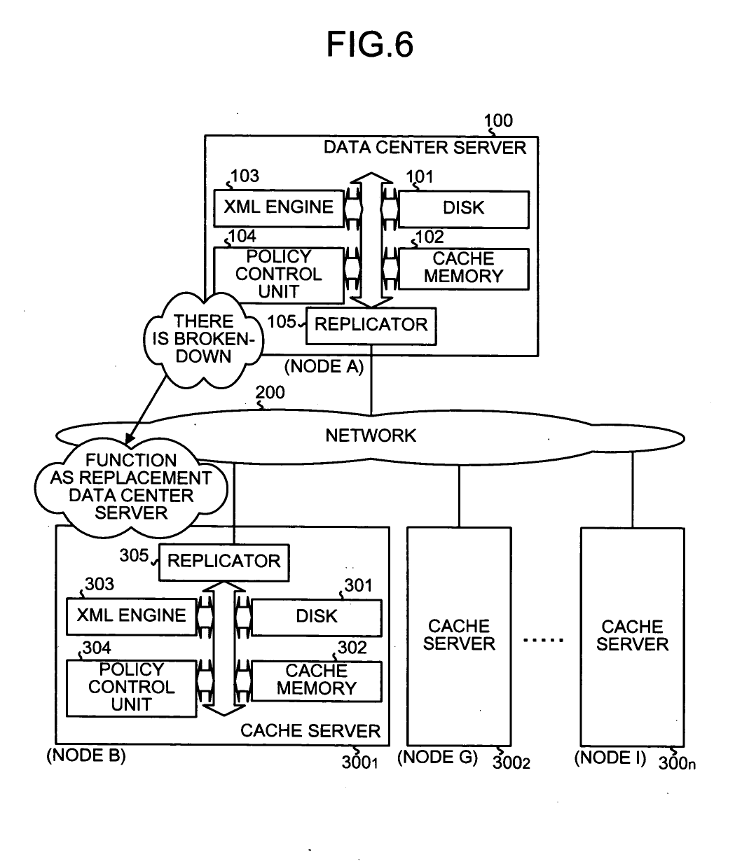

A server replacement operation in the case of breakdown of the data center server 100 is discussed next with reference to FIG. 5 and FIG. 6. FIG. 5 is a flowchart for explaining the operation in cache servers 300₁, through 300ₙ illustrated in FIG. 6 when there is a breakdown of data center server 100.

In Step SC1, the replicator 305 of the cache server 300₁ shown in FIG. 6 checks for breakdown of the data center server 100 based on the periodical viability checks. If the replicator 305 does not detect a breakdown, that is, if the check result is “No”, the replicator 305 continues the periodical viability checks. Similarly, the assessment of Step SC1 is executed for each of the cache servers 300₂ through 300ₙ.

When the replicator 305 of the cache server 300₁ detects a breakdown of the data center server 100, that is if the check result of Step SC1 is “Yes”, in Step SC2, the policy control unit 304 of the cache server 300₁ refers to the group list (function) of the policy data 500 (see FIG. 2) and checks whether a replacement data center server is specified. If the policy control unit 304 assesses that a replacement data center server is specified, that is, if the check result of Step SC2 is “Yes”, the process proceeds to Step SC3.

In Step SC3, the policy control unit 304 of the cache server 300₁ checks whether the replacement server level has the highest level of priority. The replacement server level (not shown) is specified in the group list of the policy data 500 (see FIG. 2). The replacement server level indicates the order of priority of replacement servers when plural cache servers are specified to function as replacement data center servers.

In this case, assuming that the replacement server level of the cache server 300₁ has the highest level of priority, the policy control unit 304 of the cache server 300₁ assesses that the replacement server has the highest level of priority, that is, the check result of Step SC3 is “Yes”. In Step SC7, the policy control unit 304 of the cache server 300₁ checks whether the cache server 300₁ carries out normal operation. If the check result is “No”, the cache server 300₁ cannot function as a replacement data center server due to breakdown.

If the check result of Step SC7 is “Yes”, in Step SC8, the policy control unit 304 of the cache server 300₁ sends a message to the cache servers 300₂ through 300ₙ conveying that the cache server 300₁ is functioning as a data center server in place of the data center server 100.

In the case of breakdown of the data center server 100, the cache server 300₂ assesses that there is a breakdown of the data center server 100, that is, the check result of Step SC1 is “Yes”. In Step SC2, the cache server 300₂ refers to the group list (function) of the policy data 500 (see FIG. 2) and checks whether a replacement data center server is specified. If the replacement data center server is specified, the cache server 300₂ assesses that a replacement data center server is specified, that is, the check result is “Yes”, and the process proceeds to Step SC3.

In Step SC3, it is checked whether the cache servers 300₂ through 300ₙ have the highest level of priority. If the check result is “No”, in Step SC4, it is checked whether the cache servers 300₂ through 300ₙ have received the replacement server message from the replacement data center server (in this case, the cache server 300₁).

The check result of Step SC4 is “Yes” when the cache servers 300₂ through 300ₙ receive the replacement server message from the replacement data center server (in this case, the cache server 300₁). In this manner, the cache server 300₁ comes to function as a data center server. The cache servers 300₂ through 300ₙ recognize the cache server 300₁ as a data center server.

If the check result of Step SC4 is “No”, in SC5 the cache servers 300₂ through 300ₙ check for a breakdown of the replacement data (in this case, the cache server 300₁) as well.

The assessment of Step SC3 is carried out for cache servers 300₂ through 300ₙ by decreasing the replacement server level by one from the highest level of priority. In this way, the cache server that has the next highest priority to the cache server 300₁ functions as the next replacement data center server.

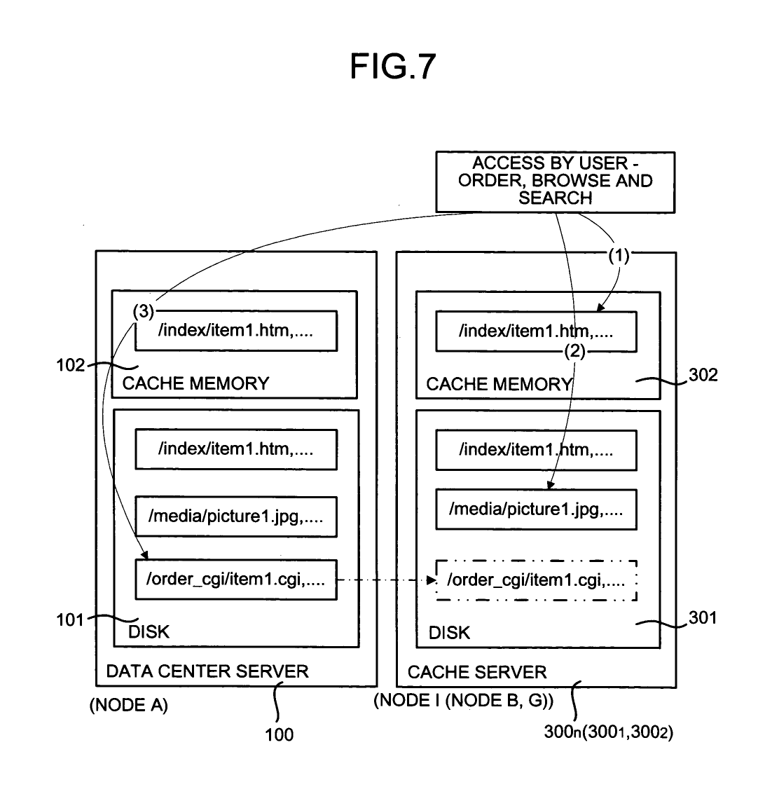

FIG. 7 is a drawing that explains the process involved in accessing data in which updation sequence is crucial by citing a case of a user purchasing products online. The parts in each unit in FIG. 7 that correspond to identical parts in FIG. 1 are assigned the same reference numerals. First, when the client 400 (see FIG. 1) operated by a general user searches for products, as shown in (1), data/index/item1.htm, . . . , which is stored in the cache memory 302 of the cache server 300ₙ at node I (which functions only as a cache server), is accessed. When browsing the products, as shown in (2), /media/picture1.jpg . . . , which is stored on the disk 301 of the cache server 300ₙ , is accessed. In this case, the service performance is maintained since the cache server 300ₙ alone is accessed.

Further, when ordering products, as shown in (3), cache server 300ₙ is bypassed and/order_cgi/item1.cgi . . . , which is stored on the disk 101 of the data center server 100, is accessed.

The data/order_cgi/item1.cgi . . . is backed up in case of the cache servers 300₁ at node B or 300₂ at node G (either which functions as a replacement data center server).

To sum up, according to an embodiment of the present invention, since the data is stored in a recording medium (such as a disk, a cache memory) of a predetermined node based on a policy data 500 (see FIG. 2) that is pre-specified taking into account the characteristics of the data for storage, the response when accessing the data can be improved.

According to an embodiment of the present invention, the script (programming language) contained in the data for storage is checked, as shown in Step SA2 of FIG. 3, and if the check result returns an error, the storing of the data is suspended. Consequently, harmful data can be forestalled.

According to an embodiment of the present invention, if a breakdown is detected at node A (data center server 100), the function of node A is realized by a local node (for example, node B). Thus, reliability of the system can be realized by providing a backup on the system.

A program for realizing the functions of the data center server 100 and the cache servers 300₁ through 300ₙ may be recorded on a computer-readable recording medium 700, and a computer 600 may be made to read the program recorded on this recording medium 700 in order to realize the functions described above.

The computer 600 comprises a CPU (Central Processing Unit) 610 that executes the program, an input device 620, such as a keyboard and a mouse, a ROM (Read Only Memory) 630 that stores various kinds of data, a RAM (Random Access Memory) 640 that stores arithmetic parameters, and the like, a reading device 650 that reads the program from the recording medium 700, an output device 660, such as a display and a printer, and a bus 670 which connects all the devices.

The CPU 610 realizes the functions described above by reading the program recorded on the recording medium 700 by means of the reading device 650 and executing the program. The recording medium 700, may be an optical disc, a flexible disk, a hard disk, and the like.

According to the present invention, data for storage is stored in a recording medium of a predetermined node based on a pre-specified policy taking into account the characteristics of the data for storage, thereby improving the response when accessing the data.

According to present invention, the programming language contained in the data for storage is checked, and if a check result returns an error, the storing of the data is suspended, thus forestalling harmful data.

According to the present invention, if a breakdown is detected at a node, the function of the node is realized by a local node. Thus, the reliability of the system can be realized by providing a backup on the system.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

### INDUSTRIAL APPLICABILITY

A data storage control program and a data storage control method is useful for storing data in a recording medium, such as a disk, cache memory, etc. of a predetermined node, based on a policy.

1. A computer program that contains instructions which when executed on a computer realize the steps of:
receiving data for storage;
referring to a policy that is pre-specified by taking into account characteristics of the data for storage; and
storing the data for storage on a recording medium of a predetermined node based on the referring.

2. The computer program according to claim 1, further causes the computer to realize the step of checking a programming language contained in the data for storage,
wherein the storing includes not storing the data for storage when the checking indicates an error.

3. The computer program according to claim 1, further causes the computer to realize the steps of:
monitoring breakdown of a specific node; and
realizing function of the specific node at a local node when breakdown of the specific node is confirmed at the monitoring.

4. A method for data storage control, comprising:
receiving data for storage;
referring to a policy that is pre-specified by taking into account characteristics of the data for storage; and
storing the data for storage on a recording medium of a predetermined node based on the referring.

5. The method according to claim 4, further comprising checking a programming language contained in the data for storage,
wherein the storing includes not storing the data for storage when the checking indicates an error.

6. The method according to claim 4, further comprising:
monitoring breakdown of a specific node; and
realizing function of the specific node at a local node when breakdown of the specific node is confirmed at the monitoring.

7. An apparatus for data storage control, comprising:
receiving unit that receives data for storage;
a policy referring unit that refers to a policy that is pre-specified by taking into account characteristics of the data for storage; and
control unit that provides a control to store the data for storage on a recording medium of a predetermined node based on the referring.

8. The apparatus according to claim 7, further comprising a checking unit that checks a programming language contained in the data for storage,
wherein the control unit provides a control so as not to store the data for storage when checking by the checking unit indicates an error.

9. The apparatus according to claim 7, further comprising:
monitoring breakdown of a specific node; and
realizing function of the specific node at a local node when breakdown of the specific node is confirmed at the monitoring.

10. A computer-readable recording medium that stores a computer program that contains instructions which when executed on a computer realize the steps of:
receiving data for storage;
referring to a policy that is pre-specified by taking into account characteristics of the data for storage; and
storing the data for storage on a recording medium of a predetermined node based on the referring.

11. The computer-readable recording medium according to claim 10, wherein the computer program further causes the computer to realize the step of checking a programming language contained in the data for storage,
wherein the storing includes not storing the data for storage when the checking indicates an error.

12. The computer-readable recording medium according to claim 10, wherein the computer program further causes the computer to realize the steps of:
monitoring breakdown of a specific node; and
realizing function of the specific node at a local node when breakdown of the specific node is confirmed at the monitoring.
